(19) United States
(12) Patent Application Publication
(10) Pub. No.: US 2026/0095351 A1
(43) Pub. Date: Apr. 2, 2026

(54) IMPLEMENTATION OF DECISION FEEDBACK EQUALIZER'S SIGN BIT USING REFERENCE VOLTAGE MULTIPLEXER

(71) Applicant: Micron Technology, Inc., Boise, ID (US)

(72) Inventor: Youngkwon Jo, Meridian, ID (US)

(21) Appl. No.: 19/222,479

(22) Filed: May 29, 2025

Related U.S. Application Data
(60) Provisional application No. 63/699,922, filed on Sep. 27, 2024.

(51) Int. Cl. H04L 25/03

(52) U.S. Cl. CPC H04L 25/03057

(57) ABSTRACT

A selection device outside of a feedback loop of a DFE circuit is used to selectively output a reference signal based on a sign bit stored in one or more mode registers. The reference signal includes a reference voltage signal, which is used by an amplifier or an equalizer of the DFE circuit to generate a corrected signal for the distorted signal. By generating the reference signal using the selection device outside of the feedback loop of the DFE circuit, the feedback loop delay time is reduced and the total operation time of the DFE circuit is reduced. Accordingly, the efficiency of the DFE circuit is improved.

### CROSS-REFERENCE TO RELATED APPLICATIONS

This application claims priority to U.S. Provisional Application No. 63/699,922, filed Sep. 27, 2024, which is incorporated by reference herein in its entirety.

### BACKGROUND

### Field of the Invention

Embodiments of the present disclosure relate generally to the field of semiconductor memory devices. More specifically, embodiments of the present disclosure relate to a loop unrolled decision feedback equalizer (DFE) architecture of a semiconductor memory device.

### Description of the Related Art

The operational rate of memory devices, including the data rate of a memory device, has been increasing over time. As a side effect of the increase in speed of a memory device, data errors due to distortion may increase. For example, inter-symbol interference between transmitted data whereby previously received data influences the currently received data may occur (e.g., previously received data affects and interferes with subsequently received data). One manner to correct for this interference is through the use of a decision feedback equalizer (DFE) circuit, which may be programmed to offset (i.e., undo, mitigate, or offset) the effect of the channel on the transmitted data.

Additionally, correcting distortions in the transmitted signals continues to be important. However, conventional distortion correction techniques may not adequately correct the distortions of the signal. Errors that result from slow processes of conventional distortion correction techniques cause additional distortions to the final data, thus reducing the reliability of data transmitted within the memory devices. One manner to correct for this slow process is through the use of a loop unrolled decision feedback equalizer (DFE) circuit, which means possible decisions for a single previous data bit are processed in parallel with respective latches. However, DFE circuits generally use a sign bit inside the feedback loop to determine appropriate distortion corrections, which may result in increased feedback loop delay time.

### BRIEF DESCRIPTION OF THE DRAWINGS

Various aspects of this disclosure may better be understood upon reading the following detailed description and upon reference to the drawings in which:

FIG. 1 is a simplified block diagram illustrating certain features of a memory device, according to an embodiment of the present disclosure;

FIG. 2 illustrates a block diagram illustrating a data transceiver of the I/O interface of FIG. 1, according to an embodiment of the present disclosure;

FIG. 3 illustrates a block diagram of an embodiment of the data transceiver of FIG. 2, according to an embodiment of the present disclosure;

FIG. 4 illustrates a block diagram of a second embodiment of the data transceiver of FIG. 2, according to an embodiment of the present disclosure;

FIG. 5 illustrates a block diagram of a distortion correction circuit, according to an embodiment of the present disclosure;

FIG. 6 illustrates an embodiment of a distortion correction circuit using reference voltage multiplexers for implementing a sign bit in a loop unrolled DFE, according to an embodiment of the present disclosure;

FIG. 7 illustrates another embodiment of a distortion correction circuit using reference voltage multiplexers for implementing a sign bit in a loop unrolled DFE, according to an embodiment of the present disclosure; and

FIG. 8 illustrates a flow diagram of a method for implementing a sign bit to generate a corrected bit, according to an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Using a decision feedback equalizer (DFE) of a memory device to perform distortion correction techniques may be valuable, for example, to correctly compensate for distortions in the received data of the memory device. This insures that accurate values are being stored in the memory of the memory device. The DFE may use previous bit data to create corrective values to compensate for distortion resulted from the previous bit data. For example, the most recent previous bit may have more of a distortion effect on the current bit than a bit transmitted several data points before, causing the corrective values to be different between the two bits. With these levels to correct for, the DFE may operate to correct the distortion of the transmitted bit.

In some embodiments, the DFE may utilize multiple bits of previous data in order to precisely calculate the distortion correction factor. In further embodiments, when multiple bits are received and processed, a DFE may not receive a corrective voltage for a distorted bit from the most recent bit, as there may be an added time delay of correcting a distorted bit while waiting for the corrective voltage from the most recent bit. Loop unrolling techniques and associated hardware reduce the delay in correcting distorted bits due to delays in receiving previous bits by applying a correction to the distorted bit from an assumed value of the previous bit (e.g., assumed logic high or logic low), and passing this bit to a selection circuit. Once the previous bit is known, a selection of the correct distorted bit is made from the distorted bit corrected based on the assumption. Loop unrolling techniques and associated hardware may allow for multiple bits to be received and processed nearly simultaneously, leading to a very efficient system that may process distortions of received bits more quickly than may be accomplished via traditional DFE solutions. However, DFE circuits generally use a sign bit to determine appropriate distortion corrections, which may result in increased feedback loop delay time. Accordingly, it is desired to improve the DFE circuits to reduce the feedback loop delay time.

The current disclosure herein provides systems and methods for using a selection device outside of a feedback loop of a DFE circuit to selectively output a reference signal based on a sign bit stored in one or more mode registers. The reference signal includes a reference voltage signal, which is used by an amplifier or an equalizer of the DFE circuit to generate a corrected signal for the distorted signal. By generating the reference signal using the selection device outside of the feedback loop of the DFE circuit, the feedback loop delay time is reduced and the total operation time of the DFE circuit is reduced. Accordingly, the efficiency of the DFE circuit is improved.

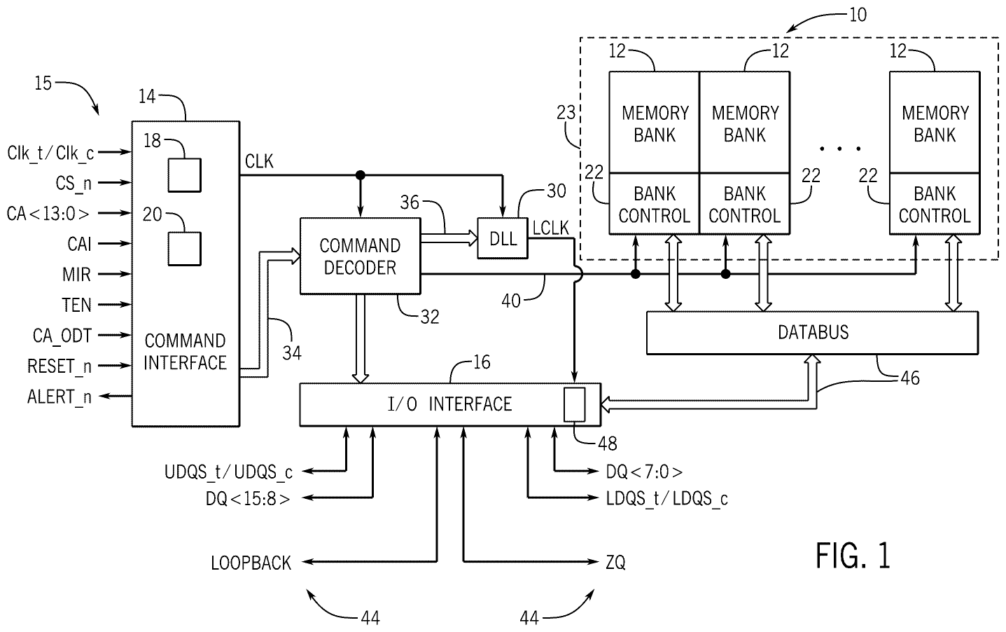

Turning now to the figures, FIG. 1 is a simplified block diagram illustrating certain features of a memory device 10. Specifically, the block diagram of FIG. 1 is a functional block diagram illustrating certain functionality of the memory device 10. In accordance with one embodiment, the memory device 10 may be a double data rate type five synchronous dynamic random access memory (DDR5 SDRAM) device. Various features of DDR5 SDRAM allow for reduced power consumption, more bandwidth and more storage capacity compared to prior generations of DDR SDRAM.

The memory device 10, may include a number of memory banks 12. The memory banks 12 may be DDR5 SDRAM memory banks, for instance. The memory banks 12 may be provided on one or more chips (e.g., SDRAM chips) that are arranged on dual inline memory modules (DIMMS). Each DIMM may include a number of SDRAM memory chips (e.g., x8 or x16 memory chips), as will be appreciated. Each SDRAM memory chip may include one or more memory banks 12. The memory device 10 represents a portion of a single memory chip (e.g., SDRAM chip) having a number of memory banks 12. For DDR5, the memory banks 12 may be further arranged to form bank groups. For instance, for an 8 gigabit (Gb) DDR5 SDRAM, the memory chip may include 16 memory banks 12, arranged into 8 bank groups, each bank group including 2 memory banks. For a 16 GB DDR5 SDRAM, the memory chip may include 32 memory banks 12, arranged into 8 bank groups, each bank group including 4 memory banks, for instance. Various other configurations, organization and sizes of the memory banks 12 on the memory device 10 may be utilized depending on the application and design of the overall system.

The memory device 10 may include a command interface 14 and an input/output (I/O) interface 16 configured to exchange (e.g., receive and transmit) signals with external devices. The command interface 14 is configured to provide a number of signals (e.g., signals 15) from an external device (not shown), such as a processor or controller. The processor or controller may provide various signals 15 to the memory device 10 to facilitate the transmission and receipt of data to be written to or read from the memory device 10.

As will be appreciated, the command interface 14 may include a number of circuits, such as a clock input circuit 18 and a command address input circuit 20, for instance, to ensure proper handling of the signals 15. The command interface 14 may receive one or more clock signals from an external device. Generally, double data rate (DDR) memory utilizes a differential pair of system clock signals, referred to herein as the true clock signal (Clk_t) and the complementary clock signal (Clk_c). The positive clock edge for DDR refers to the point where the rising true clock signal Clk_t crosses the falling complementary clock signal Clk_c, while the negative clock edge indicates that transition of the falling true clock signal Clk_t and the rising of the complementary clock signal Clk_c. Commands (e.g., read command, write command, etc.) are typically entered on the positive edges of the clock signal and data is transmitted or received on both the positive and negative clock edges.

The clock input circuit 18 receives the true clock signal (Clk_t) and the complementary clock signal (Clk_c) and generates an internal clock signal CLK. The internal clock signal CLK is supplied to an internal clock generator 30, such as a delay locked loop (DLL) circuit. The internal clock generator 30 generates a phase controlled internal clock signal LCLK based on the received internal clock signal CLK. The phase controlled internal clock signal LCLK is supplied to the I/O interface 16, for instance, and is used as a timing signal for determining an output timing of read data.

The internal clock signal CLK may also be provided to various other components within the memory device 10 and may be used to generate various additional internal clock signals. For instance, the internal clock signal CLK may be provided to a command decoder 32. The command decoder 32 may receive command signals from the command bus 34 and may decode the command signals to provide various internal commands. For instance, the command decoder 32 may provide command signals to the internal clock generator 30 over the bus 36 to coordinate generation of the phase controlled internal clock signal LCLK. The phase controlled internal clock signal LCLK may be used to clock data through the I/O interface 16, for instance.

Further, the command decoder 32 may decode commands, such as read commands, write commands, mode-register set commands, activate commands, etc., and provide access to a particular memory bank 12 corresponding to the command, via the bus path 40. As will be appreciated, the memory device 10 may include various other decoders, such as row decoders and column decoders, to facilitate access to the memory banks 12. In one embodiment, each memory bank 12 includes a bank control block 22 which provides the necessary decoding (e.g., row decoder and column decoder), as well as other features, such as timing control and data control, to facilitate the execution of commands to and from the memory banks 12. Collectively, the memory banks 12 and the bank control blocks 22 may be referred to as a memory array 23.

The memory device 10 executes operations, such as read commands and write commands, based on the command/address signals received from an external device, such as a processor. In one embodiment, the command/address bus may be a 14-bit bus to accommodate the command/address signals (CA<13:0>). The command/address signals are clocked to the command interface 14 using the clock signals (Clk_t and Clk_c). The command interface may include a command address input circuit 20 which is configured to receive and transmit the commands to provide access to the memory banks 12, through the command decoder 32, for instance. In addition, the command interface 14 may receive a chip select signal (CS_n). The CS_n signal enables the memory device 10 to process commands on the incoming CA<13:0> bus. Access to specific banks 12 within the memory device 10 is encoded on the CA<13:0> bus with the commands.

In addition, the command interface 14 may be configured to receive a number of other command signals. For instance, a command/address on die termination (CA_ODT) signal may be provided to facilitate proper impedance matching within the memory device 10. A reset command (RESET_n) may be used to reset the command interface 14, status registers, state machines and the like, during power-up for instance. The command interface 14 may also receive a command/address invert (CAI) signal which may be provided to invert the state of command/address signals CA<13:0> on the command/address bus, for instance, depending on the command/address routing for the particular memory device 10. A mirror (MIR) signal may also be provided to facilitate a mirror function. The MIR signal may be used to multiplex signals so that they can be swapped for enabling certain routing of signals to the memory device 10, based on the configuration of multiple memory devices in a particular application. Various signals to facilitate testing of the memory device 10, such as the test enable (TEN) signal, may be provided, as well. For instance, the TEN signal may be used to place the memory device 10 into a test mode for connectivity testing.

The command interface 14 may also be used to provide an alert signal (ALERT_n) to the system processor or controller for certain errors that may be detected. For instance, an alert signal (ALERT_n) may be transmitted from the memory device 10 if a cyclic redundancy check (CRC) error is detected. Other alert signals may also be generated. Further, the bus and pin for transmitting the alert signal (ALERT_n) from the memory device 10 may be used as an input pin during certain operations, such as the connectivity test mode executed using the TEN signal, as described above.

Data may be sent to and from the memory device 10, utilizing the command and clocking signals discussed above, by transmitting and receiving data signals 44 through the I/O interface 16. More specifically, the data may be sent to or retrieved from the memory banks 12 over the data bus 46, which includes a plurality of bi-directional data buses. Data I/O signals, generally referred to as DQ signals, are generally transmitted and received in one or more bi-directional data busses. For certain memory devices, such as a DDR5 SDRAM memory device, the I/O signals may be divided into upper and lower bytes. For instance, for an x16 memory device, the I/O signals may be divided into upper and lower I/O signals (e.g., DQ<15:8> and DQ<7:0>) corresponding to upper and lower bytes of the data signals, for instance.

To allow for higher data rates within the memory device 10, certain memory devices, such as DDR memory devices may utilize data strobe signals, generally referred to as DQS signals. The DQS signals are driven by the external processor or controller sending the data (e.g., for a write command) or by the memory device 10 (e.g., for a read command). For read commands, the DQS signals are effectively additional data output (DQ) signals with a predetermined pattern. For write commands, the DQS signals are used as clock signals to capture the corresponding input data. As with the clock signals (Clk_t and Clk_c), the data strobe (DQS) signals may be provided as a differential pair of data strobe signals (DQS_t and DQS_c) to provide differential pair signaling during reads and writes. For certain memory devices, such as a DDR5 SDRAM memory device, the differential pairs of DQS signals may be divided into upper and lower data strobe signals (e.g., UDQS_t and UDQS_c; LDQS_t and LDQS_c) corresponding to upper and lower bytes of data sent to and from the memory device 10, for instance.

An impedance (ZQ) calibration signal may also be provided to the memory device 10 through the I/O interface 16. The ZQ calibration signal may be used to tune output drivers and on die termination (ODT) values of external pins (e.g., DQ pad, CA pad) by adjusting pull-up and pull-down driver units of the memory device 10 across changes in process, voltage and temperature (PVT) values. Because PVT characteristics may impact the driver unit values, resistances of the driver units may fluctuate from predefined values (e.g., 240Ω). The driver units are made tunable, and the ZQ calibration signal may be used to calibrate the resistances of the driver units to the predefined values by using an external resistor having precise resistance.

This process is called ZQ calibration. As will be appreciated, a precision resistor is generally coupled between a ZQ pad on the memory device 10 and GND/VSS external to the memory device 10. This precision resistor acts as a reference for the ZQ calibration.

In addition, a loopback signal (LOOPBACK) may be provided to the memory device 10 through the I/O interface 16. The loopback signal may be used during a test or debugging phase to set the memory device 10 into a mode wherein signals are looped back through the memory device 10 through the same pin. For instance, the loopback signal may be used to set the memory device 10 to test the data output of the memory device 10. Loopback may include both a data and a strobe or possibly just a data pin. This is generally intended to be used to monitor the data captured by the memory device 10 at the I/O interface 16.

As will be appreciated, various other components such as power supply circuits (for receiving external VDD and VSS signals), mode registers (to define various modes of programmable operations and configurations), read/write amplifiers (to amplify signals during read/write operations), temperature sensors (for sensing temperatures of the memory device 10), etc., may also be incorporated into the memory system 10. Accordingly, it should be understood that the block diagram of FIG. 1 is only provided to highlight certain functional features of the memory device 10 to aid in the subsequent detailed description.

In some embodiments, the memory device 10 may be disposed in (physically integrated into or otherwise connected to) a host device or otherwise coupled to a host device. The host device may include any one of a desktop computer, laptop computer, pager, cellular phone, personal organizer, portable audio player, control circuit, camera, etc. The host device may also be a network node, such as a router, a server, or a client (e.g., one of the previously-described types of computers). The host device may be some other sort of electronic device, such as a copier, a scanner, a printer, a game console, a television, a set-top video distribution or recording system, a cable box, a personal digital media player, a factory automation system, an automotive computer system, or a medical device. (The terms used to describe these various examples of systems, like many of the other terms used herein, may share some referents and, as such, should not be construed narrowly in virtue of the other items listed.) The host device may, thus, be a processor-based device, which may include a processor, such as a microprocessor, that controls the processing of system functions and requests in the host. Further, any host processor may comprise a plurality of processors that share system control. The host processor may be coupled directly or indirectly to additional system elements of the host, such that the host processor controls the operation of the host by executing instructions that may be stored within the host or external to the host.

As discussed above, data may be written to and read from the memory device 10, for example, by the host whereby the memory device 10 operates as volatile memory, such as Double Data Rate DRAM (e.g., DDR5 SDRAM). The host may, in some embodiments, also include separate non-volatile memory, such as read-only memory (ROM), PC-RAM, silicon-oxide-nitride-oxide-silicon (SONOS) memory, metal-oxide-nitride-oxide-silicon (MONOS) memory, polysilicon floating gate based memory, and/or other types of flash memory of various architectures (e.g., NAND memory, NOR memory, etc.) as well as other types of memory devices (e.g., storage), such as solid state drives (SSD's), MultimediaMediaCards (MMC's), SecureDigital (SD) cards, CompactFlash (CF) cards, or any other suitable device. Further, it should be appreciated that the host may include one or more external interfaces, such as Universal Serial Bus (USB), Peripheral Component Interconnect (PCI), PCI Express (PCI-E), Small Computer System Interface (SCSI), IEEE 1394 (Firewire), or any other suitable interface as well as one or more input devices to allow a user to input data into the host, for example, buttons, switching elements, a keyboard, a light pen, a stylus, a mouse, and/or a voice recognition system, for instance. The host may optionally also include an output device, such as a display coupled to the processor and a network interface device, such as a Network Interface Card (NIC), for interfacing with a network, such as the Internet. As will be appreciated, the host may include many other components, depending on the application of the host.

The host may operate to transfer data to the memory device 10 for storage and may read data from the memory device 10 to perform various operations at the host.

Accordingly, to facilitate these data transmissions, in some embodiments, the I/O interface 16 may include a data transceiver 48 that operates to receive and transmit DQ signals to and from the I/O interface 16.

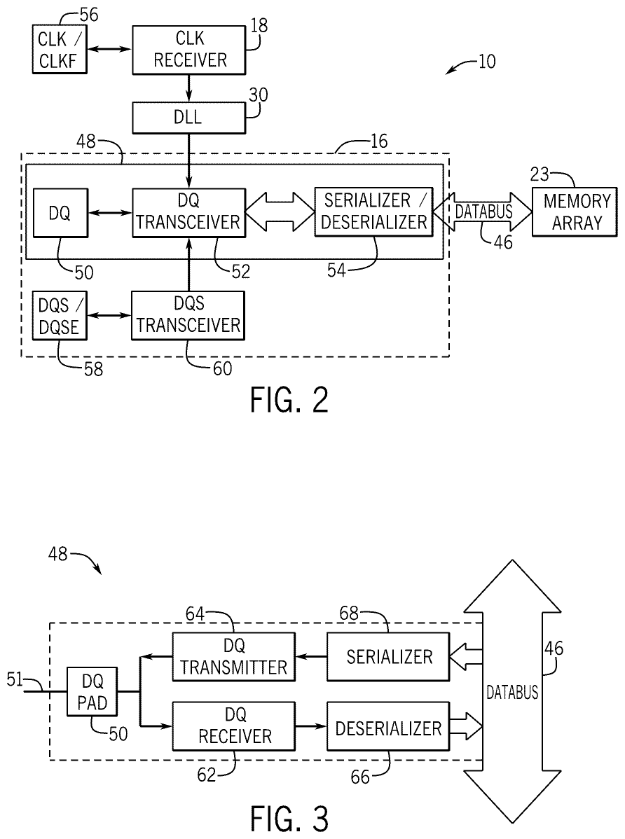

FIG. 2 illustrates the I/O interface 16 of the memory device 10 generally and, more specifically, the data transceiver 48. As illustrated, the data transceiver 48 of the I/O interface 16 may include a DQ connector 50, a DQ transceiver 52, and a serializer/deserializer 54. It should be noted that in some embodiments, multiple data transceivers 48 may be utilized that each single data transceiver 48 may be utilized in connection with a respective one of each of upper and lower I/O signals (e.g., DQ<15:8> and DQ<7:0>) corresponding to upper and lower bytes of the data signals, for instance. Thus, the I/O interface 16 may include a plurality of data transceivers 48, each corresponding to one or more I/O signals (e.g., inclusive of a respective DQ connector 50, DQ transceiver 52, and serializer/deserializer 54).

The DQ connector 50 may be, for example a pin, pad, combination thereof, or another type of interface that operates to receive DQ signals, for example, for transmission of data to the memory array 23 as part of a data write operation. Additionally, the DQ connector 50 may operate to transmit DQ signals from the memory device 10, for example, to transmit data from the memory array 23 as part of a data read operation. To facilitate these data reads/writes, a DQ transceiver 52 is present in data transceiver 48. In some embodiments, for example, the DQ transceiver 52 may receive a clock signal generated by the internal clock generator 30 as a timing signal for determining an output timing of a data read operation from the memory array 23. The clock signal transmitted by the internal clock generator 30 may be based upon one or more clocking signals received by the memory device 10 at clock connector 56 (e.g., a pin, pad, the combination thereof, etc.) and routed to the internal clock generator 30 via the clock input circuit 18. Thus, the DQ transceiver 52 may receive a clock signal generated by the internal clock generator 30 as a timing signal for determining an output timing of a data read operation from the memory array 23.

The DQ transceiver 52 of FIG. 2 may also, for example, receive one or more DQS signals to operate in strobe data mode as part of a data write operation. The DQS signals may be received at a DQS connector 58 (e.g., a pin, pad, the combination thereof, etc.) and routed to the DQ transceiver 52 via a DQS transceiver 60 that operates to control a data strobe mode via selective transmission of the DQS signals to the DQ transceiver 52. Thus, the DQ transceiver 52 may receive DQS signals to control a data write operation from the memory array 23.

As noted above, the data transceiver 48 may operate in modes to facilitate the transfers of the data to and from the memory device 10 (e.g., to and from the memory array 23). For example, to allow for higher data rates within the memory device 10, a data strobe mode in which DQS signals are utilized, may occur. The DQS signals may be driven by an external processor or controller sending the data (e.g., for a write command) as received by the DQS connector 58 (e.g., a pin, pad, the combination thereof, etc.). In some embodiments, the DQS signals are used as clock signals to capture the corresponding input data.

In addition, as illustrated in FIG. 2, the data transceiver 48 also includes a serializer/deserializer 54 that operates to translate serial data bits (e.g., a serial bit stream) into a parallel data bits (e.g., a parallel bit stream) for transmission along data bus 46 during data write operations of the memory device 10. Likewise, the serializer/deserializer 54 operates to translate parallel data bits (e.g., a parallel bit stream) into serial data bits (e.g., a serial bit stream) during read operations of the memory device 10. In this manner, the serializer/deserializer 54 operates to translate data received from, for example, a host device having a serial format into a parallel format suitable for storage in the memory array 23. Likewise, the serializer/deserializer 54 operates to translate data received from, for example, the memory array 23 having a parallel format into a serial format suitable for transmission to a host device.

FIG. 3 illustrates the data transceiver 48 as including the DQ connector 50 coupled to data transfer bus 51, a DQ receiver 62, a DQ transmitter 64 (which in combination with the DQ receiver 62 forms the DQ transceiver 52), a deserializer 66, and a serializer 68 (which in combination with the deserializer 66 forms the serializer/deserializer 54). In operation, the host (e.g., a host processor or other memory device described above) may operate to transmit data in a serial form across data transfer bus 51 to the data transceiver 48 as part of a data write operation to the memory device 10. This data is received at the DQ connector 50 and transmitted to the DQ receiver 62. The DQ receiver 62, for example, may perform one or more operations on the data (e.g., amplification, driving of the data signals, etc.) and/or may operate as a latch for the data until reception of a respective DQS signal that operates to coordinate (e.g., control) the transmission of the data to the deserializer 66. As part of a data write operation, the deserializer 66 may operate to convert (e.g., translate) data from a format (e.g., a serial form) in which it is transmitted along data transfer bus 51 into a format (e.g., a parallel form) used for transmission of the data to the memory array 23 for storage therein.

Likewise, during a read operation (e.g., reading data from the memory array 23 and transmitting the read data to the host via the data transfer bus 51), the serializer 68 may receive data read from the memory array in one format (e.g., a parallel form) used by the memory array and may convert (e.g., translate) the received data into a second format (e.g., a serial form) so that the data may be compatible with one or more of the data transfer bus 51 and/or the host. The converted data may be transmitted from the serializer 68 to the DQ transmitter 64, whereby one or more operations on the data (e.g., de-amplification, driving of the data signals, etc.) may occur. Additionally, the DQ transmitter 64 may operate as a latch for the received data until reception of a respective clock signal, for example, from the internal clock generator 30, that operates to coordinate (e.g., control) the transmission of the data to the DQ connector 50 for transmission along the data transfer bus 51 to one or more components of the host.

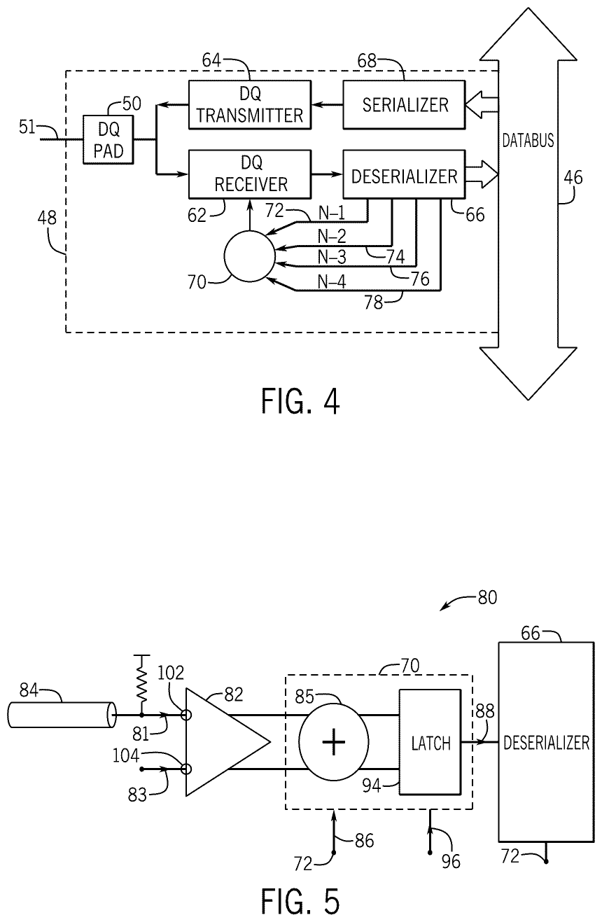

In some embodiments, the data received at the DQ connector 50 may be distorted. For example, data received at the DQ connector 50 may be affected by inter-symbol interference (ISI) in which previously received data interferes with subsequently received data. For example, due to increased data volume being transmitted across the data transfer bus 51 to the DQ connector 50, the data received at the DQ connector 50 may be distorted relative to the data transmitted by the host. One technique to mitigate (e.g., offset or cancel) this distortion and to effectively reverse the effects of ISI is to apply an equalization operation to the data. FIG. 4 illustrates an embodiment of the data transceiver 48 inclusive of an equalizer that may be used in this equalization operation.

FIG. 4 illustrates one embodiment of the data transceiver 48 inclusive of an equalizer, in particular, a decision feedback equalizer (DFE) 70. As illustrated, the DFE 70 is a multi-tap (e.g., four-tap) DFE 70. However, less or more than four taps may be utilized in conjunction with the DFE 70. Likewise, the DFE 70 may be disposed separate from or internal to the deserializer 66 or the DQ receiver 62. In operation, a binary output (e.g., from a latch or decision-making slicer) is captured in one or more data latches or data registers. In the present embodiment, these data latches or data registers may be disposed in the deserializer 66 and the values stored therein may be latched or transmitted along paths 72, 74, 76, and 78.

When a data bit is received at the DQ receiver 62, it may be identified as being transmitted from the host as bit “n” and may be received at a time t₀ as distorted bit n (e.g., bit n having been distorted by ISI). The most recent bit received prior to distorted bit n being received at the DQ receiver 62, e.g., received at time of t₋₁ that immediately precedes time of t₀, may be identified as n-1 and is illustrated as being transmitted from a data latch or data register along path 72. The second most recent bit received prior to distorted bit n being received at the DQ receiver 62, e.g., received at time of t₋₂ that immediately precedes time of t₋₁, may be identified as n-2 and is illustrated as being transmitted from a data latch or data register along path 74. The third most recent bit received prior to distorted bit n being received at the DQ receiver 62, e.g., received at time of t₋₃ that immediately precedes time of t₋₂, may be identified as n-3 and is illustrated as being transmitted from a data latch or data register along path 76. The fourth most recent bit received prior to distorted bit n being received at the DQ receiver 62, e.g., received at time of t₋₃ that immediately precedes time of t₋₂, may be identified as n-4 and is illustrated as being transmitted from a data latch or data register along path 78. Bits n-1, n-2, n-3, and n-4 may be considered the group of bits that interfere with received distorted bit n (e.g., bits n-1, n-2, n-3, and n-4 cause ISI to host transmitted bit n) and the DFE 70 may operate to offset the distortion caused by the group of bits n-1, n-2, n-3, and n-4 on host transmitted bit n. Thus, the values latched or transmitted along paths 72, 74, 76, and 78 may correspond, respectively, to the most recent previous data values (e.g., preceding bits n-1, n-2, n-3, and n-4) transmitted from the DQ receiver 62 to be stored in memory array 23. These previously transmitted bits are fed back along paths 72, 74, 76, and 78 to the DFE 70, which operates to generate weighted taps/tap biases (e.g., voltages) that may be added to the received input signal (e.g., data received from the DQ connector 50, such as distorted bit n) by means of a summer (e.g., a summing amplifier). In other embodiments, the weighted taps (e.g., voltages) may be combined with an initial reference value to generate an offset that corresponds to or mitigates the distortion of the received data (e.g., mitigates the distortion of distorted bit n). In some embodiments, taps are weighted to reflect that the most recent previously received data (e.g., bit n-1) may have a stronger influence on the distortion of the received data (e.g., distorted bit n) than bits received at earlier times (e.g., bits n-1. n-2, and n-3). The DFE 70 may operate to generate tap biases (e.g., voltages), including magnitudes and polarities, for taps due to each previous bit to collectively offset the distortion caused by those previously received bits.

The polarity of a tap bias for a tap is the sign bit for that tap, which may be stored in mode registers. For example, for a +50 mV tap bias, the polarity is “+” and the sign bit is high (e.g., “1”); while for a −50 mV tap bias, the polarity is “−” and the sign bit is low (e.g., “0”). A sign bit may be used to select (e.g., by a multiplexer) a feedback (e.g., one of DFE's output and inverted DFE's output) or an adjusted reference value (e.g., a reference signal for an amplifying device). For instance, the ISI may have two types of residue. The first type of residue is greater than zero and the second type of residue is less than zero. A sign bit option may be used for the DFE to process both cases. For example, if the sign bit is low, the residue is assumed to be greater than zero and corresponding feedback for the first type of ISI may be selected; if the sign bit is high, the residue is assumed to be less than zero and corresponding feedback for the second type of ISI may be selected. For example, for the first type of ISI, when the previous data has a logic high (e.g., “1”), a reference value (e.g., a reference voltage of an amplifier) may be increased; and when the previous data has a logic low (e.g., “0”), the reference value may be decreased. For example, for the second type of ISI, when the previous data has a logic high (e.g., “1”), a reference value (e.g., a reference voltage of an amplifier) may be decreased; and when the previous data has a logic low (e.g., “0”), the reference value may be increased.

For example, for the present embodiment, each of previously received bits n-1, n-2, n-3, and n-4 could have had one of two values (e.g., a binary 0 or 1), which was transmitted to the deserializer 66 for transmission to the memory array 23 and, additionally, latched or saved in a register for subsequent transmission along respective paths 72, 74, 76, and 78. In the illustrated embodiment, this leads to sixteen (e.g., 2⁴) possible binary combinations (e.g., 0000, 0001, 0010, . . . , 1110, or 1111) for the group of bits n-1, n-2, n-3, and n-4. The DFE 70 operates to select and/or generate corresponding tap values for whichever of the aforementioned sixteen combinations are determined to be present (e.g., based on the received values along paths 72, 74, 76, and 78) to be used to adjust either the input value received from the DQ connector 50 (e.g., distorted bit n) or to modify a reference value (e.g., a reference signal for an amplifying device) that is subsequently applied to the input value received from the DQ connector 50 (e.g., distorted bit n) so as to cancel the ISI distortion from the previous bits in the data stream (e.g., the group of bits n-1, n-2, n-3, and n-4).

Use of distortion correction (e.g., a DFE 70) may be beneficial such that data transmitted from the DQ connector 50 is correctly represented in the memory array 23 without distortion. Accordingly, it may be useful to store the previous bit data to use in the distortion correction. As illustrated in the block diagram of FIG. 5, a distortion correction circuit 80 may be included as part of the DQ receiver 62 but may not be required to be physically located there (e.g., the distortion correction circuit 80 may instead be coupled to the DQ receiver 62). In some embodiments, the distortion correction circuit 80 may be operated to provide previously transmitted bit data to correct a distorted bit 81 (e.g., bit having been distorted by ISI and/or system distortions) transmitted via a channel 84 (e.g., connection, transmission line, and/or conductive material).

The distorted bit 81 may be transmitted to an amplifying device 82 (e.g., variable gain amplifier) from a channel 84. The distorted bit 81 may be transmitted from the amplifying device 82 to the DFE 70, illustrated as having a single weighted tap 86. The distorted bit 81 may be transmitted simultaneously with a DQ reference signal 83 to the DFE 70. The DQ reference signal 83 may represent a threshold value (e.g., a voltage level) for determination if the transmitted bit received by the DQ connection 50 was a logical low (e.g., 0) or a logical high (e.g., 1).

The DFE 70 may be operated to correct the distortion of the distorted bit 81 (e.g., n bit data) using the weighted tap of the previous bit data (e.g., n-1 bit data). Data (e.g., logical 1 or logical 0) for an n-1 bit may be transmitted through the path 72. The magnitudes and polarities (i.e., sign bit) of the single weighted tap 86 may offset the total distortion caused by the n-1 bit via summer circuit 85, which operates as a current summer that applies current to the distorted bit 81 to offset for distortion caused by the n-1 bit. For example, if the received bit at the DQ connection 50 is determined to be below the DQ reference signal 83, the received bit 81 is transmitted to the memory array 23 as a logical low. The magnitude and polarity (i.e., sign bit) of the weighted tap 86 may be determined to correct the distorted bit 81 and the DQ reference signal 83. The sign bit of the weighted tap 86 may be used to select (e.g., via a multiplexer) a feedback or an adjusted reference value based on the type of the ISI.

A modified version of the distorted bit 81 and a modified version of the DQ reference signal 83 may be transmitted to a data latch 94. A corrected bit 88 may be generated via the data latch 94 and transmitted from the data latch 94 to the deserializer 66, which may occur on the rising edge of the DQS signal 96. In other embodiments, variations of the clocking scheme may be followed to be inclusive of additional or alternative methods of data transmission. The value for the new n-1 bit may be stored, for example, in the deserializer 66 for transmission along the path 72 when the corrected bit 88 is received in the deserializer 66.

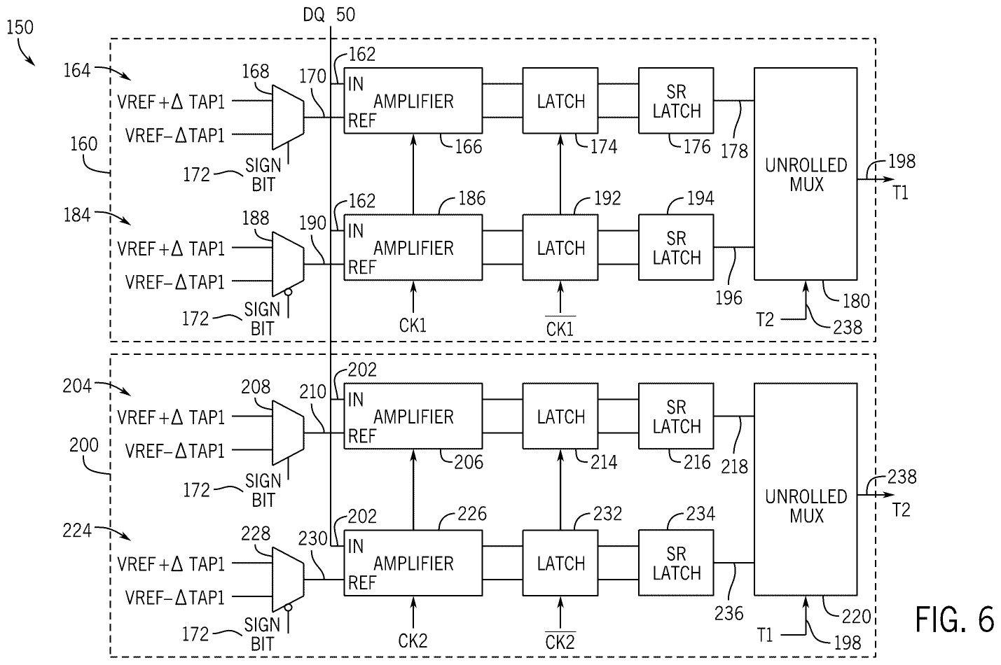

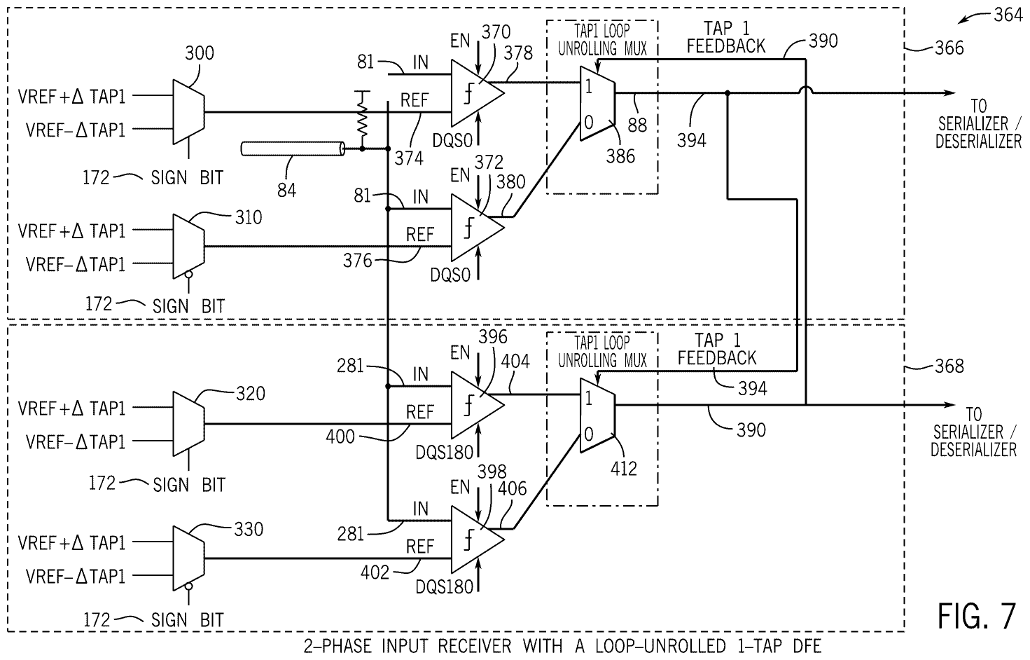

As illustrated in FIG. 5, the distortion correction circuit 80 may include multiple elements in a feedback loop for correcting distortions in the bit 81, such as the amplifying device 82 (e.g., variable gain amplifier), the summer circuit 85, the data latch 94, etc. Accordingly, a feedback loop delay time may occur due to the processing time of the multiple elements in the feedback loop and the time used to generate the signals used in the feedback loop (e.g., the weighted tap 86). In some embodiments, the tap biases (e.g., voltages), including magnitudes and polarities (i.e., sign bits) may be determined (e.g., during DQ training) and fixed during normal operation, and the values of the tap biases (e.g., for various taps and/or weight options) may be stored in mode register settings. Accordingly, sign bits may be fixed during normal operation and obtained from the mode register settings. The feedback loop delay time may be reduced by using a selection device (e.g. a multiplexer) outside of the feedback loop of the DFE circuit to select the feedback or the adjusted reference value for the DFE circuit based on the mode register settings for the sign bit. For example, a multiplexer may be used outside of the feedback loop of the DFE 70 to select an adjusted value for the DQ reference signal 83 of the amplifying device 82 based on the determined sign bit of the weighted tap 86, which may reduce the total feedback loop delay time. In some embodiments, a loop unrolled DFE circuit may be used to obtain distortion corrections faster by processing possible decisions for a single previous data bit in parallel with respective latches. In some loop unrolled DFE circuits, a sign bit may be used to select (e.g., via a multiplexer) a feedback or an adjusted reference value based on the type of the ISI, which may cause a corresponding time delay. The feedback loop delay time may be reduced by using a selection device (e.g. a multiplexer) outside of the feedback loop of the unrolled DFE circuit to select the feedback or the adjusted reference value, as illustrated in FIG. 6 and FIG. 7.

FIG. 6 illustrates an embodiment of a distortion correction circuit 150 for a 2-phase input receiver with a loop unrolled 1-tap DFE, which implements sign bits to select adjusted values for reference voltages of the amplifiers. The distortion correction circuit 150 may include a first circuit 160 for processing one bit received at CK1, i.e., at the first phase (e.g., the rising edge of the DQS signal 96) and a second circuit 200 for processing one bit received at CK2, i.e., at the second phase (e.g., the falling edge of the DQS signal 96). For example, a first distorted bit 162 may be received by the first circuit 160 at CK1, a second distorted bit 202 may be received by the second circuit 200 at CK2, and a third distorted bit may be rolled back to be received by the first circuit 160 once the first iteration of the distortion correction is complete.

As illustrated in FIG. 6, the first circuit 160 may include two paths to process, in parallel, possible decisions (e.g., “1” or “0”) of a previous bit T2 determined by the second circuit 200, respectively. For instance, the first circuit 160 may include a T2 high path 164 corresponding to the previous bit T2 being a logic high (e.g., “1”) and a T2 low path 184 corresponding to the previous bit T2 being a logic low (e.g., “0”). As mentioned previously, there may be two types of ISI, with the first type corresponding to the sign bit being a logic low and the second type corresponding to the sign bit being a logic high. For the first type of ISI, when the previous bit has a logic high (e.g., “1”), a reference value (e.g., a reference voltage) may be increased (e.g., V_{REF}+Δtap1); when the previous bit has a logic low (e.g., “0”), the reference value may be decreased (e.g., V_{REF}−Δtap1). For the second type of ISI, when the previous bit has a logic high (e.g., “1”), the reference value may be decreased (e.g., V_{REF}−Δtap1) ; when the previous bit has a logic low (e.g., “0”), the reference value may be increased (e.g., V_{REF}+Δtap1). Accordingly, the sign bit may be used to select corresponding reference values (e.g., “V_{REF}+Δtap1”or “V_{REF}−Δtap1”) for the T2 high path 164 and the T2 low path 184.

As illustrated in FIG. 6, the T2 high path 164 may include an amplifier 166 to receive the first distorted bit 162. The T2 high path 164 may include a selection device 168 (e.g., a multiplexer) to select a reference value 170 (e.g., a reference voltage) for the amplifier 166 based on a sign bit 172. For the first type of ISI, when the previous bit T2 has a logic high (e.g., “1”), the reference value 170 may be increased (e.g., V_{REF}+Δtap1); while for the second type of ISI, when the previous bit T2 has a logic high (e.g., “1”), the reference value 170 may be decreased (e.g., V_{REF}−Δtap1). Accordingly, the sign bit 172 may be used to select a corresponding value for the reference value 170 (e.g., “V_{REF}+Δtap1” or “V_{REF}−Δtap1”). The T2 high path 164 may include a latch 174 and a SR latch 176 to process the distorted bit 162 using the reference value 170, and a result 178 from the SR latch 176 may be sent to a selection device 180 (e.g., an unrolled multiplexer) together with a result obtained from the T2 low path 184.

As illustrated in FIG. 6, the T2 low path 184 may include an amplifier 186 to receive the first distorted bit 162. The T2 low path 184 may include a selection device 188 (e.g., a multiplexer) to select a reference value 190 (e.g., a reference voltage) for the amplifier 186 based on the sign bit 172. For the first type of ISI, when the previous bit T2 has a logic low (e.g., “0”), the reference value 190 may be decreased (e.g., V_{REF}−Δtap1); while for the second type of ISI, when the previous bit T2 has a logic low (e.g., “0”), the reference value 190 may be increased (e.g., V_{REF}+Δtap1). Accordingly, the sign bit 172, or the inversion of the sign bit 172 as illustrated in the embodiment of FIG. 6, may be used to select a corresponding value for the reference value 190 (e.g., “V_{REF}−Δtap1” or “V_{REF}+Δtap1”). The T2 high path 184 may include a latch 192 and a SR latch 194 to process the distorted bit 162 using the reference value 190, and a result 196 of the SR latch 194 may be sent to the selection device 180 (e.g., an unrolled multiplexer) together with the result 178 obtained from the T2 high path 164. The selection device 180 may make the final decision on which value the corrected bit 198 takes (e.g., that of the result 178 or the result 196) based on the value of the previous bit T2 (the result 238) generated by the second circuit 200. For example, when the previous bit T2 generated by the second circuit 200 has a logic high, the corrected bit 198 takes the result 178 generated by the T2 high path 164; when the previous bit T2 generated by the second circuit 200 has a logic low, the corrected bit 198 takes the result 196 generated by the T2 low path 184.

As illustrated in FIG. 6, the second circuit 200 may include two paths to process, in parallel, possible decisions (e.g., “1” or “0”) of a previous bit T1 determined by the first circuit 160, respectively. For instance, the second circuit 200 may include a T1 high path 204 corresponding to the previous bit T1 being a logic high (e.g., “1”) and a T1 low path 224 corresponding to the previous bit T1 being a logic low (e.g., “0”). As mentioned previously, there may be two types of ISI, with the first type corresponding to the sign bit being a logic low and the second type corresponding to the sign bit being a logic high. For the first type of ISI, when the previous bit has a logic high (e.g., “1”), a reference value (e.g., a reference voltage) may be increased (e.g., V_{REF}+Δtap1); when the previous bit has a logic low (e.g., “0”), the reference value may be decreased (e.g., V_{REF}−Δtap1). For the second type of ISI, when the previous bit has a logic high (e.g., “1”), the reference value may be decreased (e.g., V_{REF}−Δtap1) ; when the previous bit has a logic low (e.g., “0”), the reference value may be increased (e.g., V_{REF}+Δtap1). Accordingly, the sign bit may be used to select corresponding reference values (e.g., “V_{REF}+Δtap1”or “V_{REF}−Δtap1”) for the T1 high path 204 and the T1 low path 224.

As illustrated in FIG. 6, the T1 high path 204 may include an amplifier 206 to receive the first distorted bit 202. The T1 high path 204 may include a selection device 208 (e.g., a multiplexer) to select a reference value 210 (e.g., a reference voltage) for the amplifier 206 based on the sign bit 172. For the first type of ISI, when the previous bit T1 has a logic high (e.g., “1”), the reference value 210 may be increased (e.g., V_{REF}+Δtap1); while for the second type of ISI, when the previous bit T1 has a logic high (e.g., “1”), the reference value 210 may be decreased (e.g., V_{REF}−Δtap1). Accordingly, the sign bit 172 may be used to select a corresponding value for the reference value 210 (e.g., “V_{REF}+Δtap1” or “V_{REF}−Δtap1”). The T1 high path 204 may include a latch 214 and a SR latch 216 to process the distorted bit 202 using the reference value 210, and a result 218 from the SR latch 216 may be sent to a selection device 220 (e.g., an unrolled multiplexer) together with a result obtained from the T1 low path 224.

As illustrated in FIG. 6, the T1 low path 224 may include an amplifier 226 to receive the first distorted bit 202. The T1 low path 224 may include a selection device 228 (e.g., a multiplexer) to select a reference value 230 (e.g., a reference voltage) for the amplifier 226 based on the sign bit 172. For the first type of ISI, when the previous bit T1 has a logic low (e.g., “0”), the reference value 230 may be decreased (e.g., VREF−Δtap1); while for the second type of ISI, when the previous bit T1 has a logic low (e.g., “0”), the reference value 230 may be increased (e.g., VREF+Δtap1). Accordingly, the sign bit 172, or the inversion of the sign bit 172 as illustrated in the embodiment of FIG. 6, may be used to select a corresponding value for the reference value 230 (e.g., “VREF−Δtap1” or “VREF+Δtap1”). The T1 low path 224 may include a latch 232 and a SR latch 234 to process the distorted bit 202 using the reference value 230, and a result 236 of the SR latch 234 may be sent to the selection device 220 (e.g., an unrolled multiplexer) together with the result 218 obtained from the T1 high path 204. The selection device 220 may make the final decision on which value the corrected bit 238 takes (e.g., that of the result 218 or the result 236) based on the result 198 of the previous bit T1 generated by the first circuit 160. For example, when the previous bit T1 generated by the first circuit 160 has a logic high, the corrected bit 238 takes the result 218 generated by the T1 high path 204; when the previous bit T1 generated by the first circuit 160 has a logic low, the corrected bit 238 takes the result 236 generated by the T1 low path 224.

As illustrated in the embodiment of FIG. 6, since the sign bit 172 may be determined (e.g., during DQ training) and fixed during normal operation, the selection devices (e.g., the selection devices 168, 188, 208, 228) associated with the sign bit 172 may be excluded from the feedback loop of the distortion correction circuit 150, thereby reducing the feedback loop delay time.

FIG. 7 illustrates another embodiment of a distortion correction circuit 364 of a basic 2-phase input receiver with a loop unrolled 1-tap DFE, which may be capable of processing two data bits with one bit received at DQS0, i.e., at the first phase (e.g., the rising edge of the DQS signal 96) and one bit received at DQS180, i.e., at the second phase (e.g., the falling edge of the DQS signal 96). The distortion correction circuit 364 includes a first circuit 366 and a second circuit 368, which may be distortion correction circuits similar to the distortion correction circuits 160 and 200, respectively. For instance, the distorted bit 81 may be received by the first circuit 366 at DQS0, a second distorted bit 281 may be received by the second circuit 368 at DQS180, and a third distorted bit may be rolled back to be received by the first circuit 366 once the first iteration of the distortion correction is complete.

The first circuit 366 may include two equalizers to process, in parallel, possible decisions (e.g., “1” or “0”) of a previous bit determined by the second circuit 368, respectively. For instance, the first circuit 366 may include an equalizer 370 corresponding to the previous bit being a logic high (e.g., “1”) and an equalizer 372 corresponding to the previous bit being a logic low (e.g., “0”). The sign bit 172 may be used to select corresponding reference values (e.g., “V_{REF}+Δtap1”or “V_{REF}-Δtap1”) for the equalizer 370 and the equalizer 372.

To elaborate further, the first circuit 366 may receive the distorted bit 81 and may begin to process it using the method described with the distortion correction circuit 160, and an enable signal (i.e., EN) may be used to enable or disable the corresponding equalizer (e.g., the equalizer 370 or the equalizer 372). The first circuit 366 may include a selection device 300 (e.g., a multiplexer) to select a reference value 374 (e.g., a reference voltage) for the equalizer 370 based on the sign bit 172. For the first type of ISI, when the previous bit 390 generated by the second circuit 368 has a logic high (e.g., “1”), the reference value 374 may be increased (e.g., V_{REF}+Δtap1); while for the second type of ISI, when the previous bit 390 has a logic high (e.g., “1”), the reference value 374 may be decreased (e.g., V_{REF}−Δtap1). Accordingly, the sign bit 172 may be used to select a corresponding value for the reference value 374 (e.g., “V_{REF}+Δtap1” or “V_{REF}−Δtap1”). The first circuit 366 may include a selection device 310 (e.g., a multiplexer) to select a reference value 376 (e.g., a reference voltage) for the equalizer 372 based on the sign bit 172. For the first type of ISI, when the previous bit 390 has a logic low (e.g., “0”), the reference value 376 may be decreased (e.g., V_{REF}−Δtap1); while for the second type of ISI, when the previous bit 390 has a logic low (e.g., “0”), the reference value 376 may be increased (e.g., V_{REF}+Δtap1). Accordingly, the sign bit 172, or the inversion of the sign bit 172 as illustrated in the embodiment of FIG. 7, may be used to select a corresponding value for the reference value 376 (e.g., “V_{REF}−Δtap1” or “V_{REF}+Δtap1”).

As illustrated in FIG. 7, an output 378 from the equalizer 370 and an output 380 from the equalizer 372 may be transmitted to a selection device 386 (e.g., a multiplexer) at DQS0 (e.g., the rising edge of the DQS signal 96). The selection device 386 may make the final decision on which value the corrected bit 394 takes (e.g., that of the output 378 or the output 380) based on the value of the previous bit 390 generated by the second circuit 368.

The second circuit 368 may include two equalizers to process, in parallel, possible decisions (e.g., “1” or “0”) of a previous bit determined by the first circuit 366, respectively. For instance, the first circuit 368 may include an equalizer 396 corresponding to the previous bit 394 being a logic high (e.g., “1”) and an equalizer 398 corresponding to the previous bit 394 being a logic low (e.g., “0”). The sign bit 172 may be used to select corresponding reference values (e.g., “V_{REF}+Δtap1”or “V_{REF}−Δtap1”) for the equalizer 396 and the equalizer 398.

The second circuit 368 may receive the distorted bit 281 and may begin to process it using the method described with the distortion correction circuit 366, and the enable signal (i.e., EN) may be used to enable or disable the corresponding equalizer (e.g., equalizer 396 or equalizer 398). The second circuit 368 may include a selection device 320 (e.g., a multiplexer) to select a reference value 400 (e.g., a reference voltage) for the equalizer 396 based on the sign bit 172. For the first type of ISI, when the previous bit 394 has a logic high (e.g., “1”), the reference value 400 may be increased (e.g., V_{REF}+Δtap1); while for the second type of ISI, when the previous bit 394 has a logic high (e.g., “1”), the reference value 400 may be decreased (e.g., V_{REF}−Δtap1). Accordingly, the sign bit 172 may be used to select a corresponding value for the reference value 400 (e.g., “V_{REF}+Δtap1” or “V_{REF}−Δtap1”). The first circuit 368 may include a selection device 330 (e.g., a multiplexer) to select a reference value 402 (e.g., a reference voltage) for the equalizer 398 based on the sign bit 172. For the first type of ISI, when the previous bit 394 has a logic low (e.g., “0”), the reference value 402 may be decreased (e.g., VREF-Δtap1); while for the second type of ISI, when the previous bit 394 has a logic low (e.g., “0”), the reference value 402 may be increased (e.g., V_{REF}+Δtap1). Accordingly, the sign bit 172, or the inversion of the sign bit 172 as illustrated in the embodiment of FIG. 7, may be used to select a corresponding value for the reference value 402 (e.g., “V_{REF}−Δtap1” or “V_{REF}+Δtap1”).

As illustrated in FIG. 7, an output 404 from the equalizer 396 and an output 406 from the equalizer 398 may be transmitted to a selection device 412 (e.g., a multiplexer) at DQS180 (e.g., the falling edge of the DQS signal 96). The selection device 412 may make the final decision on which value the corrected bit 390 takes (e.g., that of the output 404 or the output 406) based on the value of the previous bit 394 generated by the first circuit 366.

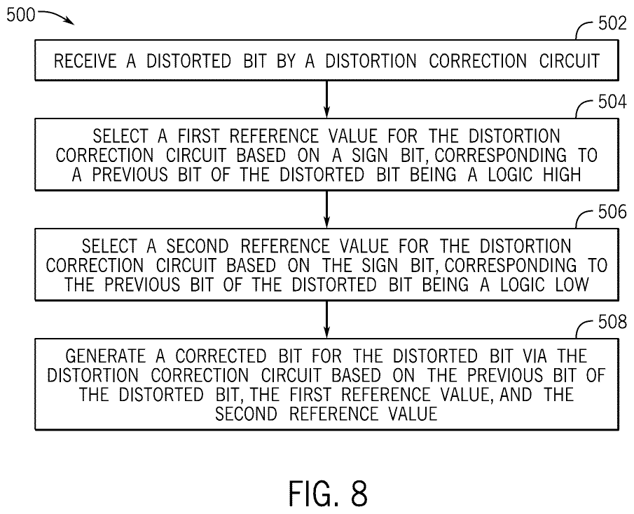

FIG. 8 is a flow diagram of a method 500 for implementing the sign bit in a distortion correction circuit. At block 502, a distortion correction circuit (e.g., the distortion correction circuit 150, 160, 200, 364, 366, or 368) may receive a distorted bit (e.g., the distorted bit 162). At block 504, a sign bit (e.g., the sign bit 172) may be used to select a first reference value (e.g., the reference value 170) corresponding to a previous bit (e.g., the T2 bit 238) of the distorted bit being a logic high, and a first possible result (e.g., the result 178) of the corrected bit of the distorted bit corresponding to the previous bit being a logic high may be determined. At block 506, the sign bit (e.g., the sign bit 172) may be used to select a second reference value (e.g., the reference value 190) corresponding to the previous bit (e.g., the T2 bit 238) of the distorted bit being a logic low, and a second possible result (e.g., the result 196) of the corrected bit of the distorted bit corresponding to the previous bit being a logic low may be determined. At block 508, a corrected bit (e.g., the bit 198) for the distorted bit may be selected from the first possible result and the second possible result by the distortion correction circuit based on the value of the previous bit (e.g., the T2 bit 238).

Although the method 500 is described in a particular order above, it should be noted that the method 500 may be performed in any suitable order and is not limited to the order presented herein. For example, the first possible result and the second possible result may be obtained in parallel.

Accordingly, the technical effects of the present disclosure include methods and systems for using a selection device outside of a feedback loop of a DFE circuit to selectively output a reference signal based on a sign bit stored in one or more mode registers. The reference signal includes a reference voltage signal, which is used by an amplifier or an equalizer of the DFE circuit to generate a corrected signal for the distorted signal. By generating the reference signal using the selection device outside of the feedback loop of the DFE circuit, the feedback loop delay time is reduced and the total operation time of the DFE circuit is reduced. Accordingly, the efficiency of the DFE circuit is improved.

In the illustrated embodiments above, the memory devices and systems are primarily described in the context of devices incorporating DRAM storage media. Memory devices configured in accordance with other embodiments of the present technology, however, may include other types of memory devices and systems incorporating other types of storage media, including PCM, SRAM, FRAM, RRAM, MRAM, read only memory (ROM), erasable programmable ROM (EPROM), electrically erasable programmable ROM (EEROM), ferroelectric, magnetoresistive, and other storage media, including non-volatile, flash (e.g., NAND and/or NOR) storage media. It should also be noted that, in the illustrated embodiments above, the DFE circuits are primarily described in the context of 1-tap DFE or loop unrolled 1-tap DFE. However, the implementation of sign bits outside of DFE feedback loops may be used in other types of DFE circuits (e.g., 2-tap, 3-tap, 4tap, loop unrolled or not unrolled).

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A device, comprising:
a selection device configured to select a reference value from a plurality of reference values based on a sign bit; and
an input receiver circuit configured to:
receive an input signal;
receive the reference value from the selection device; and
generate an adjusted signal for the input signal based on the reference value.

2. The device of claim 1, wherein the selection device comprises a multiplexer.

3. The device of claim 1, wherein a value of the sign bit is stored in one or more mode registers.

4. The device of claim 3, wherein the value of the sign bit is fixed.

5. The device of claim 1, wherein the reference value comprises a reference voltage value.

6. The device of claim 5, wherein the input receiver circuit comprises an amplifier to receive the reference value.

7. The device of claim 5, wherein the input receiver circuit comprises an equalizer to receive the reference value.

8. The device of claim 1, wherein the device comprises another selection device to select another reference value from the plurality of reference values based on an inversion of the sign bit.

9. The device of claim 8, wherein the reference value corresponds to a previous signal of the input signal being a logic high and the another reference value corresponds to the previous signal of the input signal being a logic low.

10. The device of claim 9, wherein the input receiver circuit is configured to generate the adjusted signal based on the reference value and the another reference value.

11. A method, comprising:
receiving an input signal;
selecting a first reference value from a plurality of reference values based on a sign bit;
selecting a second reference value from the plurality of reference values based on an inversion of the sign bit; and
generating an adjusted signal for the input signal based on the first reference value and the second reference value.

12. The method of claim 11, wherein a value of the sign bit is stored in one or more mode registers.

13. The method of claim 12, wherein the value of the sign bit is fixed.

14. The method of claim 11, wherein the first reference value comprises a reference voltage value.

15. An input receiver circuit, comprising:
a first component to:
receive an input signal; and
receive a first reference value selected from a plurality of reference values based on a sign bit;
a second component to:
receive the input signal; and
receive a second reference value selected from the plurality of reference values based on an inversion of the sign bit; and
a selection device to select an adjusted signal for the signal from a first result generated based on the first reference value and a second result generated based on the second reference value.

16. The circuit of claim 15, wherein a value of the sign bit is stored in one or more mode registers.

17. The circuit of claim 16, wherein the value of the sign bit is fixed.

18. The circuit of claim 15, wherein the reference value comprises a reference voltage value.

19. The circuit of claim 18, wherein the first component comprises an amplifier to receive the first reference value.

20. The circuit of claim 18, wherein the first component comprises an equalizer to receive the first reference value.
